(19) United States
(12) Patent Application Publication
(10) Pub. No.: US 2007/0121252 A1
(43) Pub. Date: May 31, 2007

(54) Actuator and hard disk drive having the same

(76) Inventors: Min-pyo Hong, Suwon-si (KR); Jeong-il Chun, Seongnam-si (KR); Yong-kyu Byun, Yongin-si (KR); Cheol-soon Kim, Anyang-si (KR); Sang-chul Shin, Osan-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/507,455

(22) Filed: Aug. 22, 2006

(30) Foreign Application Priority Data
Nov. 30, 2005 (KR) 10-2005-0115910

(51) Int. Cl. G11B 5/54; G11B 21/02

(52) U.S. Cl. 360/254; 360/75

(57) ABSTRACT

An actuator of a hard disk drive includes a swing arm having an axis or rotation, a suspension extending from a distal end of the swing arm, a read/write head mounted on the suspension, a coil support fixed to a proximate end of the swing arm so as to rotate with the swing arm and to which a voice coil motor coil is wound, a respective magnet disposed above and/or below the voice coil motor coil as facing the voice coil motor coil, and at least one magnetic retracting member of a magnetic material fixed to the coil support and attracted to the magnet. Each magnetic retracting member arrives close to the magnet when the swing arm is rotated clockwise or counterclockwise about its axis of rotation. Thus, the force of attraction between the magnetic retracting member and the magnet biases the wing arm in one of its directions of rotation such as that in which the swing arm is moved during an unloading operation in which the read/write head is parked.

### BACKGROUND OF THE INVENTION

1. Field of the Invention

The present invention relates to a hard disk drive. More particularly, the present invention relates to an actuator of a hard disk drive.

2. Description of the Related Art

As one of the information storage devices of a computer, a hard disk drive (HDD) reproduces data stored on a disk or records data onto the disk using a read/write head. To this end, a head of the HDD reads or writes the data from or onto a recording surface the disk while the disk is rotating and the head is spaced a predetermined distance from the recording surface of the disk. The head itself is moved to a desired position over the recording surface of the disk by an actuator.

FIG. 1 is a perspective view of a conventional HDD. Referring to FIG. 1, the conventional HDD includes a disk 10 for storing data, a spindle motor 20 for rotating the disk 10, and an actuator 30 for moving a read/write head 34 to a desired position over the disk 10 to record and reproduce data onto and from the disk 10. The actuator 30 includes a swing arm 32 rotatably coupled to an actuator pivot 31, a suspension 33 installed at an end portion of the swing arm 32 and supporting the head 34 as biased toward the recording surface of the disk 10, and a voice coil motor (VCM, not all of which is shown) for rotating the swing arm 32 about an axis of the pivot 31. The VCM includes a VCM coil 37 wound along a coil support member 36 provided at a read end portion of the swing arm 32 and magnets 50 respectively disposed above (not shown) and below the VCM coil 37.

The VCM rotates the swing arm 32 in a direction according to Fleming's left hand rule due to the flow of current through the VCM coil 37 and the magnetic field formed by the magnets 50. That is, when the power to the HDD is turned on and the disk 10 starts to rotate at a constant angular velocity Ω, the VCM rotates the swing arm 32 in a predetermined direction, for example, counterclockwise, to move the head 34 above the recording surface of the disk 10. The head 34 is maintained at a predetermined height above the surface of the disk 10 by a lift force generated by the disk 10 that is rotating. In this state, the head 34 follows a particular track T of the disk 10 to record data onto the recording surface of the disk 10 or reproduce data stored on the recording surface of the disk 10.

In the meantime, when the power is turned off and the disk 10 stops rotating, the VCM rotates the swing arm 32 in the opposite direction, for example, clockwise. Accordingly, the head 34 is moved off of the recording surface of the disk 10 and is parked on a ramp 60 located radially outwardly of the disk 10. More specifically, a lift tab 35 protrudes from the end of the suspension 33. The lift tab 35 moves along the ramp 60 and is ultimately set on a support surface of the ramp 60 to park the head 34.

In the HDD as described above, numerous sources of resistance affect the rotation of the swing arm 32. For example, the pivot 31 of the actuator offers resistance in the direction of rotation of the swing arm 32, a printed circuit ribbon 70 attached to the side of the swing arm 32 offers resistance corresponding to the flexibility of the ribbon, and the ramp 60 and the lift tab 35 create friction that resists the rotation of the swing arm 32. Thus, the VCM needs to supply a rotational force to the swing arm 32 that is great enough to overcome these resistances. However, the need to keep the drive apparatus compact imposes a limit on the maximum output of the VCM.

Alternatively, a relatively high drive current can be supplied to the VCM coil 37 to attain the required dynamic characteristic of the actuator 30 such as rapid response. However, with this solution, the power consumption of the actuator 30 is high and its operating efficiency is thus correspondingly low. Moreover, the circuit board which provides power to the HDD needs to be redesigned so as to be suitable for handling a large amount of current.

In addition, after the head 34 is parked on the ramp 60, the head 34 may nonetheless be separated from the ramp 60 and moved above the disk 10 by shock applied to the HDD. At this time, a lift force is not applied to the head 34 by the disk 10 because the disk 10 is not rotating. As a result, the head 34 can collide with the recording surface of the disk 10 and become damaged, thereby permanently damaging the HDD or making it impossible to reproduce data recorded on the disk 10.

### SUMMARY OF THE INVENTION

An object of the present invention is to overcome one or more of the problems, limitations and disadvantages of the conventional hard disk drive.

A more specific object of the present invention is to provide a rotatable actuator having an improved dynamic characteristic, and a hard disk drive including the same.

Another object of the present invention is to provide a hard disk drive that is shock resistant, and an actuator that provides the hard disk drive with an anti-shock characteristic.

Still another object of the present invention is to provide a hard disk drive that can park its read/write head rapidly and yet does not require an overly complex power circuit to supply current to the voice coil motor coil to rapidly park the read/write head.

According to an aspect of the present invention, an actuator of a hard disk drive includes a swing arm having an axis or rotation, a suspension extending from a distal end of the swing arm, a read/write head mounted on the suspension, a coil support fixed to a proximate end of the swing arm so as to rotate with the swing arm and to which a voice coil motor coil is wound, a respective magnet disposed above and/or below the voice coil motor coil as facing the voice coil motor coil, and at least one retract magnetic member of a magnetic material fixed to the coil support and attracted to the magnet. Each retract magnetic member arrives close to the magnet when the swing arm is rotated clockwise or counterclockwise about its axis of rotation.

According to another aspect of the present invention, a hard disk drive comprises at least one disk for storing information, a spindle motor to which the disk is mounted for rotating the disk which is installed thereon, and an actuator including a retract magnetic member. The heard disk drive may also include a ramp on which the read/write head of the actuator is parked when not in use. Preferably, the retract magnetic member is fixed to the coil support of the actuator at a position spaced from a permanent magnet in a direction opposite to the direction in which the swing arm rotates from a loaded state to an unloaded state. Accordingly, the swing arm is biased by a magnetic force of attraction between the retract magnet member and the magnet during the unloading operation in which the end of the suspension is moved along a ramp to park the read/write head.

The ramp has a support surface that receives an end of the suspension when the swing arm is rotated in a direction that moves the read/write head off of the disk. That is, the ramp supports the suspension to park the read/write head. Preferably, the support surface includes a first inclined section that first receives the suspension during the unloading operation, and a second section extending from the inclined section parallel to the surface of the disk. The support surface may also have a second inclined section connected to the second section and inclined in a direction opposite to that in which the first inclined section extends away from the disk, and a stop accommodation section connected to the second inclined section and extending parallel to the second section.

### BRIEF DESCRIPTION OF THE DRAWINGS

The above and other objects, features and advantages of the present invention will become more apparent from the following detailed description of the preferred embodiments thereof made with reference to the attached drawings in which:

FIG. 1 is a perspective view of conventional HDD;

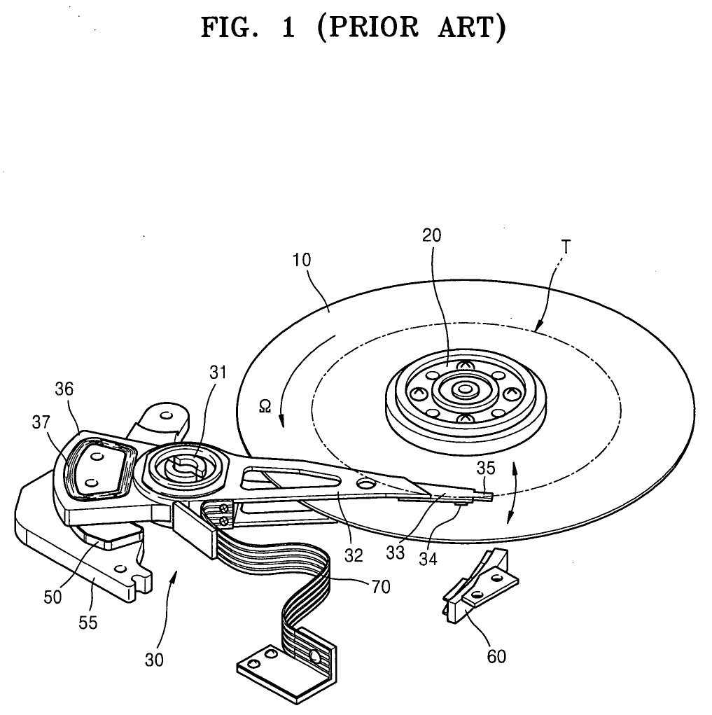

FIG. 2 is a plan view of an HDD according to the present invention, in which the read/write head of the HDD is in a loaded state;

FIG. 3 is a plan view of the actuator of the HDD of FIG. 2, in which a tab of the suspension that supports the read/write head is starting to move onto a ramp of the HDD;

FIG. 4 is a similar view, but shows the read/write head parked on the ramp;

FIG. 5 is an enlarged plan view of part of the actuator of the HDD according to the present invention, when the read/write head parked on the ramp as shown in FIG. 4; and

FIG. 6 is a sectional view of the ramp 60 and shows rotational resistance, drive torque, bias rotational force, and overall torque according to the position of the lift tab on the ramp.

### DETAILED DESCRIPTION OF THE PREFERRED EMBODIMENTS

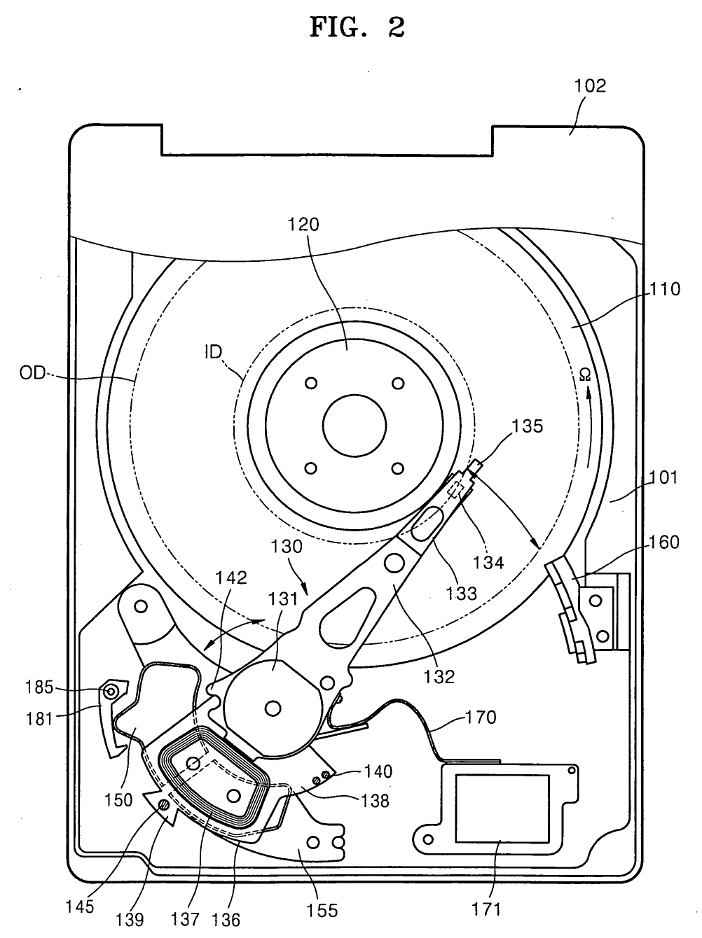

Referring to FIG. 2, a hard disk drive (HDD) according to the present invention includes at least one disk 110 for storing data, a spindle motor 120 for rotating the disk 110 at a constant angular velocity Ω, and an actuator 130 including a read/write head 134 to record and reproduce data onto and from a recording surface of the disk 110. The recording surface of the disk 110 refers to that region where information is effectively stored on the surface of the disk and does not constitute the entire surface of the disk 110. In particular, an inner peripheral region of the disk 110 (bounded by ID in FIG. 2) is reserved for use in attaching the disk 110 to the spindle motor 120 whereas an outer peripheral region of the disk 110 (bounded by OD) is reserved for the parking of the head 134 when the HDD is not in use.

The HDD also includes a base 101, and the spindle motor 120 is mounted to the base 101. In addition to the read/write head 134, the actuator 130 includes an actuator pivot 131 disposed on the base 101, a swing arm 132 for moving the read/write head 134 over the disk, a suspension 133, a coil support member 136 disposed at a proximate end portion of the swing arm 132, and a VCM coil 137 of a voice coil motor (VCM). The swing arm 132 is rotatably supported by the actuator pivot 131. The suspension 133 is coupled to a distal end of the swing arm 132, and supports the read/write head 134 so as to be biased toward a recording surface of the disk 110. The VCM coil 137 is assembled to the coil support member 136 coupled to the rear end portion of the swing arm 132.

The VCM rotates the swing arm 132 in a direction according to Fleming's left hand rule due to current flowing through the VCM coil 137 and a magnetic field formed by magnets 150. The magnets 150 are respectively disposed above and below the VCM coil 137 and face the VCM coil 137. A yoke 155 disposed on the base 101 supports the magnets 150. Each magnet 150 has the shape of an arc whose curvature corresponds to the trajectory of the VCM coil 137 with the swing arm 132. Each magnet 150 may comprise a first magnetic pole piece 150L at the left-hand side of the yoke 155 and a second magnetic pole piece 15OR at the right-hand side of the yoke which have almost equal lengths direction in the direction of rotation of the swing arm 132. The first and second magnetic pole pieces 150L and 15OR are disposed close to each other and have opposite polarities. The VCM coil 137 is located in a region of magnetic flux formed by the magnet 150 and is forced in a clockwise or counterclockwise direction in the region of magnetic flux according to the direction of the current flowing through the VCM coil 137.

The coil support member 136 has a main body to which the VCM coil 137 is mounted, and an extension 138 that protrudes from the front of the main body at a certain angle. At least one magnetic retracting member 140 is disposed on the extension 138 adjacent the magnet 150. Each magnetic retracting member 140 is formed of a magnetic material to coact with the magnet 150, i.e., to be attracted to the magnet 150. The magnetic retracting member 140 may be cylindrical (pin-shaped) or semi-spherical (mound-shaped) and may be fixed to the extension 138 in a hole formed in the extension 138. In any case, the magnet 150 exerts a strong magnetic force of attraction on the retract magnetic member 140 when the magnetic retracting member 140 is moved to within a predetermined distance from the magnet 150 as the actuator 130 rotates. At this time, the magnetic force acts to bias the actuator 130, thereby contributing to the unloading operation of the actuator 130 as will be described in more detail later.

A flexible printed circuit ribbon 170 is connected to one side of the actuator 130. The actuator 130 is moved toward the disk 110 in a loading operation and away from the disk 110 in an unloading operation by an operation signal and a stop signal, respectively, transmitted through the flexible printed circuit ribbon 170. The flexible printed circuit ribbon 170, in turn, receives a controlled drive signal or power from a circuit board (not shown) disposed beneath the base 101. To this end, a bracket 171 bridges the connection between the flexible printed circuit ribbon 170 and the circuit board. The bracket 171 is mounted to the base 101 adjacent a corner of the base 101.

Also, a cover 102 is coupled to the base 101 to form a space therewith in which the spindle motor 120 and the actuator 130 are situated. The base 101 and the cover 102 prevent foreign material from penetrating into the space to protect the parts accommodated therein. The base 101 and the cover 102 also block drive noise so that the noise is not transferred to the outside.

When power to the HDD is turned on and the disk 110 starts to rotate, the VCM rotates the swing arm 132 in one direction, for example, counterclockwise, to position the head 134 (loading operation) above the recording surface of the disk 110. The head 134 is raised off of the recording surface by a lift force generated by the rotating disk 110 and is thereby maintained at a predetermined height above the surface of the disk 110. In this state, the head 134 follows a particular track on the disk 110 to write data onto the recording surface of the disk 110 or read the data stored on the recording surface of the disk 110. On the other hand, the disk 110 stops rotating when the power is turned off. At this time, the VCM rotates the swing arm 132 in the reverse direction, for example, clockwise, so that the head 134 is moved from the recording surface of the disk 110 (unloading). The head 134 is parked on the ramp 160 which is located radially outwardly of the disk 110.

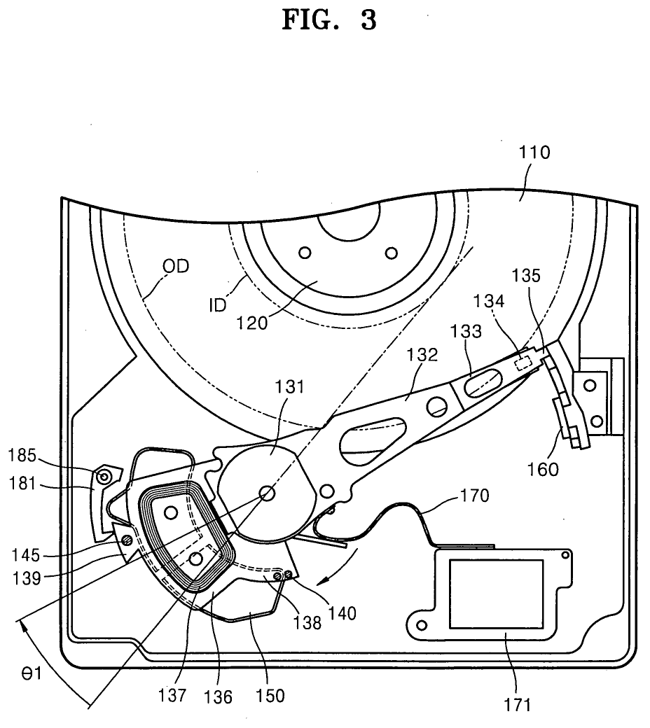

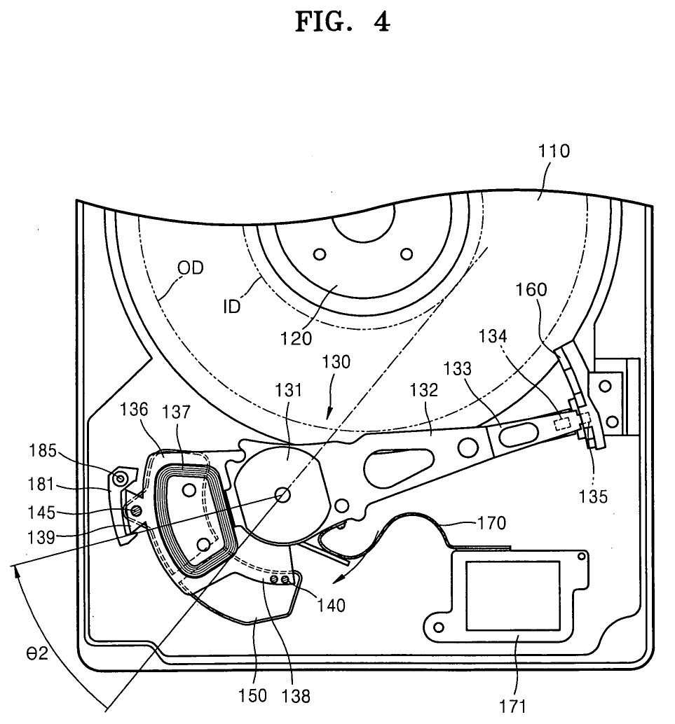

FIGS. 2, 3 and 4 show an operating sequence of the actuator. In FIG. 2, the head 134 is loaded as located adjacent the inner peripheral portion of the disk 110. In FIG. 3, the unloading operation of the actuator 130 starts. At this time, the read/write head 134 is located at the outer peripheral region of the disk 110. FIG. 4 shows the head 134 parked on the ramp 160.

More specifically, as shown in FIG. 3, the swing arm 132 is rotated clockwise over a first angle θ1 from the position shown in FIG. 2. Hence, the lift tab 135 at the tip of the swing arm 132 contacts the ramp 160 and moves up onto a guide surface of the ramp 160. At this time, though, a bearing (not shown) supporting the actuator pivot 131 offers resistance to the swing arm 132 in a direction opposite to that of the rotation of the swing arm 132. Furthermore, the guide surface of the ramp 160 and the lift tab 135 create friction corresponding to the pressure by which the suspension 133 urges the lift tab 135 against the guide surface of the ramp 160. The friction also opposes the rotation of the swing arm 132. Nonetheless, according to the present invention, the magnetic retracting member 140 rotating with the swing arm 132 is brought close to the magnet 150. Thus, a force of attraction is exerted by the magnet 150 on the magnetic retracting member 140 to assist the unloading operation, i.e., to bias the arm 132 in its direction of rotation towards the ramp 160. Accordingly, a desired rotational force can be applied to the swing arm 132 while the actuator remains relatively simple and compact and without the need to provide a relatively great amount of power to the VCM.

The distance between the magnetic retracting member 140 and the magnet 150 greatly affects the bias applied to the swing arm 132 in its direction of rotation. For example, the distance between the magnetic retracting member 140 and the magnet 150 is rather great in the loading state shown in FIG. 2. Accordingly, the force of attraction between the magnetic retracting member 140 and the magnet 150 is correspondingly weak. Thus, in the loading state, the amount of bias applied to the swing arm 132 by the magnetic retracting member 140 is negligible. Accordingly, the magnetic retracting member 140 will not cause any tracking errors to occur.

As shown in FIG. 3, when unloading operation is initiated, a strong magnetic force of attraction occurs between the magnetic retracting member 140 and the magnet 150 because the magnetic retracting member 140 is disposed close to the magnet 150. The location or shape of the magnet 150 is designed, considering the trajectory of the magnetic retracting member 140 along with the swing arm 132, to ensure that a sufficient amount force is exerted on the swing arm 132 at the initiation of the unloading operation, i.e., when the ramp 160 starts to offer resistance to the rotation of the swing arm 132. For example, the magnet 150 can be made as thick as the space between the base 101 and the cover 102 permits. Also, adding magnetic retracting members 140 can increase the amount of bias applied to the swing arm 132 without the need to alter the shape or size of the magnet 150. Therefore, as shown in FIGS. 2-5, at least two retract magnetic members 140 are provided.

Moreover, the weight or position(s) of the magnetic retracting member(s) 140 can be used to balance the swing arm 132 with respect to its axis of rotation, i.e., with respect to the actuator pivot 131. The balancing of the actuator in this way can be used to correct the posture of the actuator so that the actuator lies in a plane perpendicular to its axis of rotation. By doing so, the resistance offered by the actuator to the swing arm in its directions of rotation is minimized, i.e., the driving efficiency of the actuator and its dynamic characteristic during loading/unloading are enhanced.

After the loading operation is initiated, the swing arm 132 is rotated over a second angle θ2 to set lift tab 135 on the ramp 160 and thereby complete the unloading operation, as shown in FIG. 4. At this time, the magnetic retracting member 140 is preferably located at a position closest to the magnet 150. For example, the magnetic retracting member 140 is juxtaposed with the magnet 150. Therefore, the magnetic retracting member 140 is held in place by the magnet 150 so that any unintended rotation of the swing arm 132 can be prevented.

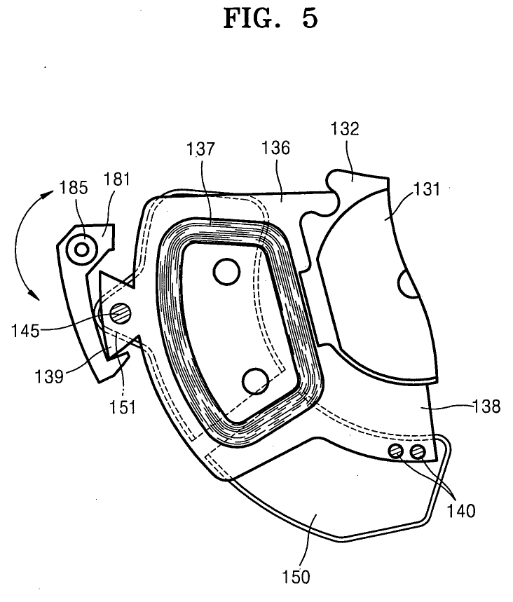

Referring now to FIG. 5, a latch can be provided at the rear of the actuator 130. The latch includes a protrusion 139 extending from the coil support member 136 and defining a notch therewith, a latch lever 181 comprising a hook, and a latch pivot 185 supporting the latch lever 181 so as to be rotatable in clockwise/counterclockwise directions. The hook of the latch lever 181 extends into the notch to engage the protrusion 139 and thereby lock the swing arm 132 in place when the read/write head 134 is parked. Thus, the latch prevents unintended rotation of the swing arm 132 from the unloaded position shown in FIG. 4. On the other hand, a suitable mechanism (not shown) is provided to rotate the latch lever 181 clockwise to release the hook of the latch lever 181 from the protrusion 139 when the power to the HDD is turned on to initiate the loading operation.

Again, referring to FIG. 5, a lock magnetic locking member 145 can be provided to also hold the swing arm 132 in place when the read/write head 134 is parked. The magnetic locking member 145 is of a magnetic material, and preferably is cylindrical (pin-shaped) or semi-spherical (mound-shaped). The lock magnetic member 145 is disposed at a position at which it will be sufficiently attracted to the magnet 150 when the read/write head 134 is parked. For example, the magnetic locking member 145 is disposed on the protrusion 139, and a portion 151 of the magnet 150 protrudes from the main body of the magnet 150 to a location corresponding to the position at which the protrusion 139 arrives when the read/write head 134 is parked. Thus, a magnetic force generated by the protruding portion 151 of the magnet 150 acts on the magnetic locking member 145 so that the magnetic locking member 145 and hence, the sing arm 132, cannot be arbitrarily rotated around the pivot shaft 131 when the swing arm 132 has been unloaded. Also, the exact position and/or mass of the locking magnetic member 145 can be designed to balance the actuator like the retract magnetic member 140.

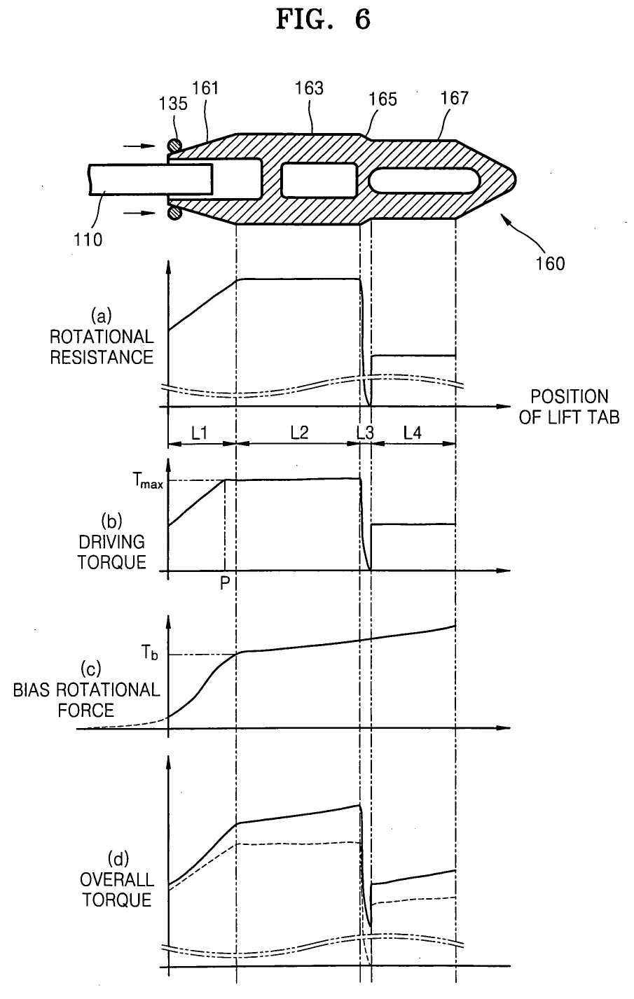

FIG. 6 shows the ramp 160 and the lift tab 135 in section as the lift tab 135 is guided by the ramp 160. Note, in FIG. 6, lift tabs 135 are shown at the upper and lower surfaces of the ramp 160. That is, the present invention also applies to an HDD in which the disk 110 has recording surfaces at each of its upper and lower surfaces, and the actuator 130 has read/write heads 134 associated with the recording surfaces respectively.

Still referring to FIG. 6, the support surface of the ramp 160 includes a plurality of contiguous sections for guiding the lift tab 135 so that the lift tab 135 is safely accommodated on the ramp 160 without the actuator 130 colliding with the disk 110. The support surface includes a first inclined section 161 provided at a location where the lift tab 135 first arrives when the read/write head 134 is moved off of the recording surface of the disk 110 and inclined at a predetermined angle in a direction away from the surface of the disk 110, a horizontal section 163 connected to the first inclined section 161 and extending parallel to the disk 110 (horizontally) in a plane spaced from that in which the surface of the disk 110 lies, a second inclined section 165 connected to the horizontal extension surface 163 and inclined in a direction opposite to that in which the first inclined surface 161 extends away from the disk, and a stop accommodation section 167 connected to the second inclined section 165 and extending parallel to the surface of the disk (horizontally).

FIG. 6 also shows the resistance exerted on the lift tab 135, the driving torque generated by the VCM, the bias force generated on the swing arm 132 by the retract magnetic member 140, and the overall torque on the swing arm 132 which is the sum of the driving torque and the bias force, according to the position of the lift tab 135 on the ramp 160. In addition to the friction between the lift tab 135 and the ramp 160, the resistance exerted on the lift tab 135 includes the resistance offered by the actuator pivot 131. However, the variations in the resistance as the lift tab 135 is displaced are mainly the result of variations in the friction between the ramp 160 and the lift tab 135.

That is, the amount of elastic deformation of the suspension 133 biasing the read/write head 134 towards the disk 110 gradually increases as the lift tab 135 moves along the first inclined section 161. Accordingly, the friction acting on the lift tab 135 and the overall resistance reflecting the same gradually increase. As shown in graph (a) of FIG. 6, the resistance in the direction of rotation increases almost linearly as the lift tab 135 moves along the first inclined section 161 (section L1 of the graph). On the other hand, the friction acting on the lift tab 135 and the overall resistance reflecting the same are maintained almost constant as the lift tab 135 moves along the horizontal section 163 (section L2 of the graph) because the elastic deformation amount of the suspension 133 is maintained constant while the lift tab 135 is guided by the horizontal section 163. The elastic deformation of the suspension 133 decreases sharply when the lift tab 135 leaves the horizontal section 163 and enters the second inclined section 165. Accordingly, the overall resistance suddenly drops when the lift tab 135 arrives at the second inclined section 165. The lift tab 135 moves smoothly across the second inclined surface 165 because the force exerted by the suspension 133 on the lift tab 135 has a component parallel to the second inclined section 165. The overall resistance to the progression of the lift tab 135 along the ramp 160 decreases to a value close to “0” as the lift tab 135 traverses the second inclined section 165 (section L3 of the graph). Finally, the overall resistance increases drastically as the lift tab 135 leaves the second inclined section 165 and arrives on the stop accommodation section 167 because, unlike with the second inclined section 165, the force exerted by the suspension 133 does not help move the lift tab 135 along the horizontal stop accommodation section 167. Subsequently, the overall resistance acting on the lift tab 135 is maintained almost constant as the lift tab 135 moves along the stop accommodation section 167 (section L4 of the graph).

Graph (b) of FIG. 6 shows a profile of the driving torque generated by the VCM. The driving torque can be increased linearly in correspondence with the linear increase in the friction generated between the lift tab 135 and the ramp 160 as the lift tab 135 moves along the first inclined section 161. However, the maximum driving torque Tₘₐₓ that the VCM can produce, at a point in time corresponding to point P in graph (b), is limited to a specific amount according to the design specifications of the VCM. Thus, the overall resistance exceeds the maximum driving torque at some point as the lift tab 135 is moving along the first inclined section 161, e.g., at the point in time represented by point P in section L1 of graph (a).

Graph (c) of FIG. 6 shows a profile of the bias in the direction of rotation applied to the swing arm 132 by the magnetic retracting member 140 of the present invention. The magnitude of the bias gradually increases as the unloading operation gets underway and sharply increases as the lift tab 135 moves along the first inclined section 161 (section L1 of graph (a)). The magnitude of the bias becomes almost equivalent to the maximum overall resistance offered against the rotation of the swing arm 132. In the present embodiment, the maximum bias T_{b} is applied after the lift tab 135 has traversed the first inclined surface 161 where the friction between the lift tab 135 and the ramp 160 is at its greatest. At this time, the magnetic retracting member 140 and the magnet 150 are relatively close to each other so that the magnetic force of attraction therebetween is relatively strong. On the other hand, as indicated by the dashed portion of the plot in the graph, the is negligible while the actuator 130 is in a loading state so as to not affect the tracking of the read/write head 134.

Graph (d) of FIG. 6 shows the sum of the driving torque of the VCM and the bias exerted by the magnetic retracting member 140 on the swing arm 132 (solid line plot) as superimposed on the overall resistance offered against the rotation of the swing arm 132 (dashed line plot). As can be seen from this figure, the magnitude of the overall torque is greater the resistance offered against the swing arm 132 in parking the read/write head 134.

In the hard disk drive according to the present invention, the load exerted by the suspension 133 must prevent the head 134 from inadvertently flying off of the surface of the disk 110, i.e., the suspension must provide the hard disk drive with an anti-shock characteristic. In the conventional hard disk drive, the anti-shock characteristic compromises the unloading operation. On the other hand, according to the present invention, the magnetic retracting member 140 biases the swing arm in its direction of rotation during unloading. Accordingly, the unloading operation is readily carried out even though the load exerted by the suspension 133 to press the read/write head 134 toward the surface of the disk 110 is great enough to provide the hard disk drive with a significant anti-shock characteristic.

In addition, the read/write head of a hard disk drive must be rapidly moved off of the disk to a parking-position in an emergency, e.g., when power to the drive is suddenly discontinued or the hard disk drive is carelessly dropped. Otherwise, a head slap may occur in which the read/write head collides with the surface of the disk. As the result of a head slap, the disk may be damaged to such an extent that data stored on the disk can not be reproduced, or the head itself may be so damaged that it can no longer function. The read/write head could be rapidly parked by designing the power supply circuit to supply the actuator with a large amount of available current in the case of an emergency. Such a solution would require a relatively complex power supply circuit. According to the present invention, however, the unloading operation is enhanced by the magnetic retracting member 140 so that it can be carried out in a minimal amount of time without the need for an overly complex power supply circuit. Therefore, a hard disk drive according to the present invention is particularly durable and reliable.

Also, according to the present invention, the magnetic retracting member 140 and the magnetic locking member 145 may be formed of a relatively heavy metallic magnetic material. Therefore, the retract magnetic member 140 and/or the magnetic locking member 145 can be used to balance the actuator. Thus, the present invention enhances the dynamic characteristic of the hard disk drive.

Furthermore, the magnetic retracting member 140 can be readily introduced into existing hard disk drives. Accordingly, the costs of implementing the present invention are minimal.

Finally, although the present invention has been particularly shown and described with reference to the preferred embodiments thereof, the present invention is not so limited. For example, the magnetic retracting member 140 has been shown and described as disposed to one side of the VCM coil so as to bias the swing arm in the unloading direction. However, the magnetic retracting member 140 can be instead disposed at the other side of the VCM coil to bias the swing arm in the loading direction for the purpose of providing the hard disk drive with a rapid response characteristic. Therefore, various changes in the form and details of the disclosed embodiments are seen to be within the true spirit and scope of the invention as defined by the appended claims.

What is claimed is:

1. An actuator of a hard disk drive comprising:
a swing arm having a distal end, a proximate end, and an axis of rotation about which axis the swing arm rotates when mounted in the drive;
a suspension extending at the distal end of the swing arm;
a read/write head mounted on the suspension;
a coil support disposed on the proximate end of the swing arm so as to rotate with the swing arm;
a voice coil motor coil wound to the coil support;
a respective magnet disposed above and/or below the voice coil motor coil as facing the voice coil motor coil; and
at least one magnetic retracting member of a magnetic material fixed to the coil support member at a position adjacent the magnet when the swing arm is located at a predetermined relative angular position with respect to its axis of rotation, wherein the magnetic retracting member is magnetically attracted to the magnet with a force sufficient to bias the swing arm in a first direction of rotation about its axis when the magnetic retracting member is located a predetermined distance from the magnet.

2. The actuator of claim 1, wherein each said at least one magnetic retracting member is spaced from the voice coil motor coil in a direction of rotation opposite to the first direction of rotation.

3. The actuator of claim 1, wherein each said at least magnetic retracting member has a cylindrical or a semi-spherical shape.

4. The actuator of claim 1, wherein each said at least one magnetic retracting member comprises at least two retract magnetic members adjacent one another on the coil support.

5. A hard disk drive comprising:
at least one disk for storing information;
a spindle motor to which the disk is mounted so as to rotate the disk; and
an actuator comprising a read/write head that reads data onto and reproduces data from the disk,
an actuator pivot,
a swing arm supported by the actuator pivot so as to be rotatable about an axis of rotation, the swing arm having a distal end and a proximate end,
a suspension extending at the distal end of the swing arm, the read/write head being mounted to the suspension, and the suspension biasing the read/write head in a direction towards the disk when the swing arm is in a loaded state in which the head is disposed over a surface of the disk,
a coil support disposed on a proximate end of the swing arm so as to rotate with the swing arm,
a voice coil motor coil wound to the coil support,
a respective magnet disposed above and/or below the voice coil motor coil as facing the voice coil motor coil, and
at least one magnetic retracting member of a magnetic material fixed to the coil support member at a position adjacent the magnet when the swing arm is located at a predetermined relative angular position with respect to its axis of rotation, wherein the magnetic retracting member is magnetically attracted to the magnet with a force sufficient to bias the swing arm in a first direction of rotation about its axis when the magnetic retracting member is located a predetermined distance from the magnet.

6. The hard disk drive of claim 5, wherein each said at least one magnetic retracting member is spaced from the voice coil motor coil in a direction of rotation opposite to the first direction of rotation.

7. The hard disk drive of claim 5, further comprising a ramp disposed at a location radially outwardly of the disk, the ramp having a support surface that receives an end of the suspension when the swing arm is rotated in a direction that moves the read/write head off of the disk, wherein the ramp supports the suspension to park the read/write head.

8. The hard disk drive of claim 7, wherein the at least one magnetic retracting member is fixed to the coil support at a position spaced from the magnet in a direction opposite to said first direction of rotation when the swing arm is in the loaded state, whereby the swing arm is biased by a magnetic force of attraction between the magnetic retracting member and the magnet during an unloading operation in which the end of the suspension is moved along the ramp to park the read/write head.

9. The hard disk drive of claim 8, wherein the support surface of the ramp has an inclined section that first receives the suspension during the unloading operation, and the inclined section terminates at a location at a level that is spaced the greatest distance from the level of the surface of the disk with respect to all other sections of the guide surface, whereby the greatest amount of friction between the suspension and the guide surface of the ramp generated during the unloading operation occurs at the location where the inclined section of the guide surface terminates.

10. The hard disk drive of claim 9, wherein the support surface of the ramp has a second section extending from the inclined section parallel to the surface of the disk.

11. The hard disk drive of claim 10, wherein the support surface of the ramp a second inclined section connected to the second section and inclined in a direction opposite to that in which the first inclined section extends away from the disk, and a stop accommodation section connected to the second inclined section and extending parallel to the second section.

12. The hard disk drive of claim 8, wherein the magnetic retracting member is juxtaposed with the magnet and is magnetically attracted thereto when the read/write head is parked on the ramp.

13. The hard disk drive of claim 5, further comprising a magnetic locking member of a magnetic material fixed to a rear end of the coil support, and wherein the magnet has a main body and a protrusion protruding from the main body and disposed at a position juxtaposed with the magnetic locking member when the read/write head is parked on the ramp, the magnetic locking member being magnetically attracted to the protruding portion of the magnet.

14. The hard disk drive of claim 5, further comprising a protrusion extending from the coil support and defining a notch therewith, a latch lever comprising a hook, and a latch pivot supporting the latch lever so as to be rotatable in clockwise/counterclockwise directions, wherein the hook of the latch lever extends into the notch to engage the protrusion and thereby lock the swing arm in place when the read/write head is parked on the ramp.

15. The hard disk drive of claim 13, further comprising a protrusion extending from the coil support and defining a notch therewith, a latch lever comprising a hook, and a latch pivot supporting the latch lever so as to be rotatable in clockwise/counterclockwise directions, wherein the hook of the latch lever extends into the notch to engage the protrusion and thereby lock the swing arm in place when the read/write head is parked on the ramp.
